(19) United States
(12) Patent Application Publication
(10) Pub. No.: US 2013/0179270 A1
(43) Pub. Date: Jul. 11, 2013

(54) COMPUTER IMPLEMENTED ENTERPRISE MARKETING SYSTEM AND METHOD FOR FACILITATING RETAIL NEGOTIATION BETWEEN MERCHANTS AND CONSUMERS

(71) Applicant: David Bryant Nolan, Layton, UT (US)

(72) Inventor: David Bryant Nolan, Layton, UT (US)

(21) Appl. No.: 13/345,902

(22) Filed: Jan. 9, 2012

Related U.S. Application Data
(63) Continuation of application No. 13/345,894, filed on Jan. 9, 2012.

(51) Int. Cl. G06Q 30/02

(52) U.S. Cl. 705/14.66

(57) ABSTRACT

A method, computer program product and system are disclosed for tracking and soliciting potential consumers of selected commercial offerings by third-parties who have subscribed to a marketing network. In some embodiments, a system forwards consumer requests for commercial offerings to merchants while also gathering information relevant to the geographic position of consumers in the marketing network. The system and method make use of mobile locator mechanism in consumer cellular phones to gather information about consumer proximity to retail business incorporated into a marketing network. Consumer requests are forwarded to a server capable of quickly identifying merchants near selected consumers, which merchants are subsequently prompted to craft commercial offerings specific to the consumer submitting the consumer request. Merchants and consumer are put into near real-time negotiations for products or services.

### CROSS-REFERENCES TO RELATED APPLICATION

This application is a continuation of, and claims priority to, U.S. patent application Ser. No. 13/345,894 entitled “Enterprise Marketing System and Computer Program Product for Facilitating Retail Negotiation Between Merchants and Consumers,” filed Jan. 9, 2011 for David Nolan, which is incorporated herein by reference.

### BACKGROUND OF THE INVENTION

1. Field of the Invention

This invention relates to computer implemented marketing processes, and more particularly relates to a computer implemented method and system for pairing consumers with merchants and facilitating price negotiations between them.

2. Description of the Related Art

Potential consumers of food, lodging, travel, and other commercial products and services must consider a great deal more information in deciding whether to patronize a business than can be displayed on traditional drive-by signage, mailers, or through more evolved marketing mechanisms, such as models managed by Groupon®, PriceLine®, Orbitz®, and the like. In deciding whether or not to patronize a business, consumers presently lack real-time information about availability of a product(s) and/or seating at a merchant business center, nor do consumers have efficiently means of comparing rates offered by one merchant to rates offering by a competing merchant in close proximity.

Merchants likewise lack real-time information about consumers necessary to effectively fix pricing. While some merchants, including restaurants, have learned that consumer demand is higher in the evenings, and consequently raise prices on their dinner menus, merchants have no efficient means of fluctuating pricing in real-time in response to fluctuating consumers demand or competitors' offers throughout the evenings or weekends. Additionally, both merchants and consumers presently lack means of negotiating in near real-time with each other.

Additionally, even profitable businesses often fail over time because of retention problems with customers, undercutting competition, or an inability on the part of the merchant to gather customer satisfaction information and react to it.

Methods, computer program products and systems are lacking in the art which track and facilitate solicitation by merchants of potential consumers of selected products. There exists no efficient means of gathering information relevant to the geographic position of consumers relative to merchants offering products or services, despite the existence of mobile locator mechanisms in consumer cellular phones. Merchants and consumer currently cannot be put into near real-time negotiations for products or services.

The present invention beneficially teaches a unique computer implemented methodology for relaying commercial offerings from select merchants to select consumers that overcomes prior shortcomings in art. The teachings of the present invention may be equally applicable to negotiations between landlords and potential tenants, as well as non-retail commercial offerings.

### SUMMARY OF THE INVENTION

From the foregoing discussion, it should be apparent that a need exists for a method, system, and computer program product for relaying commercial offerings from select merchants to select consumers. The present invention has been developed in response to the present state of the art; and, in particular, in response to the problems and needs in the art that have not yet been fully solved by currently available methods, systems, computer program products and apparatii, which invention overcomes many or all of the above-discussed shortcomings in the art. Accordingly, the present invention has been developed to provide an method, computer program product, and system for relaying commercial offerings from select merchants to select consumers.

A computer program product is disclosed, comprising a computer readable medium, having computer usable program code executable to perform operations for relaying commercial offerings from select merchants to select consumers, the operations of the computer program product comprising: incorporating a plurality of merchants into a marketing network by storing each respective merchant's name, physical address, age, telephone number, and email address in persistent computer readable memory; incorporating a plurality of consumers into a marketing network by storing each respective consumer's cellular telephone number, name, and email address in persistent computer readable memory; and prompting a consumer to create a virtual subgroup of consumers, the virtual subgroup of consumers comprising the names of a plurality of commonly acquainted consumers interested in collectively purchasing a commercial offering from a single merchant in the marketing network.

The computer program product further comprises prompting a consumer to create a consumer request by: identifying principal characteristics of a commercial offering the consumer is interested in receiving on behalf of a subgroup of consumers; prompting said consumer to rank sub-characteristics of the commercial offering which said consumer values most highly; prompting said consumer to input an expiration date for the consumer request and one or more pieces of information (this information collectively comprising the “Request Information”) from the group consisting of: a subgroup size, a subgroup budget, desired response time, and anticipated time of arrival of the subgroup.

The computer program product further comprises electronically relaying the consumer request and Request Information to a plurality of merchants in the marketing network; prompting the merchants to craft a commercial offering in the consumer request before the expiration date; prompting a merchant to upload the commercial offering to a server managing the marketing network in response to receiving the Request Information; forwarding commercial offerings crafted by a plurality of merchants and uploaded to the server to said consumer; maintaining a queue of commercial offerings made to said consumer by all merchants in the marketing until the expiration date; forwarding all commercial offerings received in response to the consumer request to one of said consumer's smart phone and said consumer's personal computer; asynchronously displaying via the Internet the queue to each merchant having crafted a commercial offering; prompting the merchants having crafted a commercial offering to revise their offering; storing the Request Information, commercial offerings, and consumer request in computer readable memory in a database for future historical data tracking; and referencing one or more of the Request Information, the commercial offering and the consumer request in generating Request Information exclusively associated with future consumer requests.

In some embodiments, the characteristics of the consumer request comprise one or more characteristics from the group consisting of food, entertainment, health/beauty, electronics, hotel/lodging accommodations, air travel, and professional services.

In other embodiments, the sub-characteristics comprise one or more characteristics from the group consisting of a price request, a discount rate request, a geographic proximity request, a time in business threshold, a ranking of a third-party organization request, a ranking of consumers in the marketing network request, a response expiration date, a fastest historical response time to previous consumer requests, and a highest level of availability.

The third-party organization may comprise one of the Better Business Bureau®, AAA®, the Michelin Guide®, Hotelstar®, Consumer Reports®, and Zagat®.

The computer program product may further comprise prompting the consumer to accept a commercial offering from the queue before the expiration date, and/or comprise prompting the consumer to accept a commercial offering from the queue upon reaching the expiration date.

The computer program product may further comprise prioritizing commercial offerings received from merchants into each group of the categories consisting of: closest in geographic proximity, time in business, and cheapest.

In some embodiments, the commercial offering is one of food. In alternative embodiment, the computer program product further comprises organizing the commercial offerings received into one of the categories from the group comprising: Mexican, Italian, American, sandwiches, soups, steak houses, pizza, Brazilian, Chinese, and Japanese.

The Request Information may further comprise information added by the server, including one or more of the group comprising: the number of requests previously made by said consumer, the number of offers previously accepted by said consumer, an age range of the consumer, dollar amounts spent in response to previous commercial offerings by said consumer, number of previous visits of said consumer to the merchant, and the frequency of visits of said consumer to other merchants in the marketing network by said consumer.

The Request Information may further comprise one or more virtual flags from the group consisting of: a first time eater flag, and a first time requester flag. The Request Information may further comprise a loyalty ranking exclusively associated with said consumer, the loyalty ranking generated by the server, the loyalty ranking a function of a number of subsequent purchases by the consumer at merchants in the marketing network who made commercial offerings to said consumer which were accepted by said consumer.

The Request Information may be electronically relayed only to merchants in the marketing network who satisfy the principal characteristics identified by said consumer. The Request Information may be electronically relayed only to merchants in the marketing network who satisfy the principal sub-characteristics identified by said consumer. The commercial offering may be crafted by the merchant comprises a discount percentage rate, a price, and one or more of an additional term, a list of products included, and an expiration date.

In some embodiments, the computer program product further comprises notifying the merchant asynchronously that the consumer request is one or more of open, expired accepted, and redeemed. In still further embodiments, the computer program product further comprises legally obligating merchants to remunerate a predetermined percentage of gross revenue generated from consumers in the marketing network to a legal entity exclusively associated with management of the server.

The computer program product may further comprise legally obligating merchants to remunerate a predetermined percentage of gross revenue generated by a merchant in the marketing network from commercial offerings accepted by consumers in the marketing network to a legal entity exclusively associated with management of the server.

In some embodiments, the computer program product may further comprise legally reducing the predetermined percentage that a merchant is obligated to pay to the legal entity in response to merchant achieving a predetermined level of revenue production for the legal entity.

The computer program product may further comprise prompting merchants in the marketing network to increase the percentage of gross revenue they will obligate themselves to pay the legal entity in return for having commercial offerings of the merchant moved up in the queue.

In some embodiments, the computer program product further comprises prompting merchants in the marketing network to bid against each other for queue position with one of dollars and percentages paid to the legal entity.

In some embodiments, the computer program product may further comprise ranking the commercial offerings within the queue on one or more criteria from the group consisting of: identified consumer preferences, price, discount rate, and proximity.

The computer program product may further comprise ranking the commercial offerings within the queue on one or more criteria from the group consisting of: identified consumer preferences, price, discount rate, and proximity.

The queue rankings may be asynchronously displayed to the merchants do not comprise competing merchant names. The queue rankings may be asynchronously displayed to the merchants have all merchant names redacted.

The computer program product may further comprise notifying a merchant receiving a consumer request that the consumer request satisfies one or more merchant defined criteria with audible tones exclusively associated with the criteria satisfied.

The computer program product may further comprise prompting the merchants crafting commercial offerings to include one of a counteroffer and a supplemental offer in the commercial offering, wherein the supplemental offer comprises a binding contract offer by the merchant to increase the discount rate offered by the merchant in response to the consumer increasing the budget.

The computer program product may further comprise offering, in response to a merchant instruction, the consumer an increased discount rate in the commercial offerings if the consumer arrives on time to the merchant place of business.

The computer program product may further comprise: assessing demerits against merchants who do not respond to consumer requests before the expiration date; and inversely ranking commercial offerings shown in the queue by merchants in accordance with the offering merchant's respective number of demerits.

In some embodiments, the computer program product further comprises prompting each merchant to set upper and lower thresholds (the thresholds defining a “Threshold Boundary” between them), wherein a consumer request comprising a budget falling outside the Threshold Boundary is automatically denied by the server on behalf of the merchant.

The computer program product may further comprise prompting each merchant to establish an upper discount rate lower threshold, wherein a consumer request comprising a discount rate request exceeding the upper threshold is automatically denied.

The upper threshold is applicable only during certain time periods of a week defined by the merchant. The computer program product may further comprise visually flagging attractive consumer requests for merchants based on historical data analysis of consumer requests previously accepted by one or more of a merchant in the marketing network and a plurality of merchants in the marketing network.

In some embodiments, the computer program product further comprises prompting a consumer who has accepted a commercial offering to rate one or more of the quality of a commercial product underlying the commercial offering, a quality of furnished service underlying the commercial offering, an overall impression of the merchant making the commercial offering.

The computer program product may further comprise: calculating a profit which a merchant receiving a consumer request would realize on a consumer request; and relaying the profit calculation to the merchant. Alternatively, the computer program product further comprises: assessing points to the consumer accepting commercial offerings based on the dollar size of the commercial offering; and rewarding the consumer in the future for accumulating point with one or more of priority relay of the consumer's consumer requests, price reductions for the consumer of commercial offerings.

In some embodiments, the computer program product further comprises: assessing demerits to a consumer for accepting a commercial offering but never redeeming the commercial offering by buying a commercial product underlying the commercial offering; and penalizing the consumer for accumulating demerits by one or more of delaying relay of consumer requests from the consumer to merchants, blocking relay of consumer requests from the consumer to merchants, and flagging consumer requests from the consumer to merchants with a virtual flag denoting an unreliable consumer.

The computer program product may further comprise featuring a commercial offering at the merchant request by relaying the commercial offering to consumers outside the subgroup, which outside consumers have not submitted a consumer request.

The computer program product may further comprise featuring a commercial offering in response to the server identifying optimally profitable commercial offerings to a legal entity based on a historical analysis of revenue generated in response to consumer redemption of the commercial offering.

A second computer program product is also disclosed comprising a computer readable medium having computer usable program code executable to perform operations for relaying commercial offerings from select merchants to select consumers, the operations of the computer program product comprising: incorporating a plurality of merchants into a marketing network by storing each respective merchant's name, physical address, age, telephone number, and email address in persistent computer readable memory; incorporating a plurality of consumers into a marketing network by storing each respective consumer's cellular telephone number, name, and email address in persistent computer readable memory; and prompting a consumer to create a virtual subgroup of consumers, the virtual subgroup of consumers comprising the names of a plurality of commonly acquainted consumers interested in collectively purchasing a commercial offering from a single merchant in the marketing network.

The computer program product also comprises prompting a consumer to create a consumer request by: identifying principal characteristics of a commercial offering the consumer is interested in receiving on behalf of a subgroup of consumers; prompting said consumer to rank sub-characteristics of the commercial offering which said consumer values most highly; prompting said consumer to input an expiration date for the consumer request and one or more pieces of information (this information collectively comprising the “Request Information”) from the group consisting of: a subgroup size, a subgroup budget, desired response time, and anticipated time of arrival of the subgroup.

The computer program product also comprises electronically relaying the consumer request and Request Information to a plurality of merchants in the marketing network; prompting the merchants to craft a commercial offering in the consumer request before the expiration date; prompting a merchant to upload the commercial offering to a server managing the marketing network in response to receiving the Request Information; forwarding commercial offerings crafted by a plurality of merchants and uploaded to the server to said consumer; maintaining a queue of commercial offerings made to said consumer by all merchants in the marketing until the expiration date; forwarding all commercial offerings received in response to the consumer request to one of said consumer's smart phone and said consumer's personal computer; relaying the queue to each merchant having crafted a commercial offering at set, predetermined intervals before the expiration date; prompting the merchants having crafted a commercial offering to improve their offering, subsequent to displaying the queue after the set interval; storing the Request Information, commercial offerings, and consumer request in computer readable memory in a database for future historical data tracking; and referencing one or more of the Request Information, the commercial offering and the consumer request in generating Request Information exclusively associated with future consumer requests.

In some embodiments, the queue is relayed using one of SMS cellular messaging, email, and asynchronous API website display. In other embodiments, the geographic location of the consumer is ascertained using mobile locator devices within the smart phones of consumers and target information from cellular carriers providing the consumer with cellular phone service. In still further embodiments, the geographic location of the consumer is displayed with the queue to merchants in the marketing network, the computer program product further comprising: prompting a merchant to forward a specialized commercial offering to a consumer who appears to be traveling in close proximity to the merchant; and forwarding the specialized commercial offering to the consumer wirelessly.

The computer program product may also comprise relaying electronic statement to the merchant showing a history of all commercial offerings created, accepted, ignored, rejected and redeemed during a predetermined interval of time, the electronic statement also showing a history of commercial offerings from one or more other merchants; retroactively changing expired commercial offerings in response to a merchant request; and predicting, based on historical data, whether the changed commercial offering would have been accepted by the consumer if changed before expiration.

In other embodiments, the computer program product further comprises relaying a consumer request only to merchants specifically identified by the consumer.

A system to perform operations for relaying commercial offerings from select merchants to select consumers is also disclosed, the system comprising: a merchant incorporation module configured to incorporate a plurality of merchants into a marketing network by storing each respective merchant's name, physical address, age, telephone number, and email address in persistent computer readable memory; a consumer incorporation module configured to incorporate a plurality of consumers into a marketing network by storing each respective consumer's cellular telephone number, name, and email address in persistent computer readable memory; and a subgroup prompter module configured to prompt a consumer to create a virtual subgroup of consumers, the virtual subgroup of consumers comprising the names of a plurality of commonly acquainted consumers interested in collectively purchasing a commercial offering from a single merchant in the marketing network.

The system further comprises a requester creator module configured to: collect principal characteristics of a commercial offering the consumer is interested in receiving on behalf of a subgroup of consumers; rank sub-characteristics of the commercial offering which said consumer values most highly; and accept an expiration date for the consumer request and one or more pieces of information (this information collectively comprising the “Request Information”) from the group consisting of: a subgroup size, a subgroup budget, desired response time, and anticipated time of arrival of the subgroup.

The system also comprises a request relayer module configured to electronically relay the consumer request and Request Information to a plurality of merchants in the marketing network; an offering crafter module configured to craft a commercial offering in response to the consumer request before the expiration date; a merchant uploader module configured to upload the commercial to a server managing the marketing network in response to receiving the Request Information; an offering forwarder module configured to forward commercial offerings crafted by a plurality of merchants and uploaded to the server to said consumer; a maintainer module configured to maintain a queue of commercial offerings made to said consumer by all merchants in the marketing until the expiration date; a forwarder module configured to forward all commercial offerings received in response to the consumer request to one of said consumer's smart phone and said consumer's personal computer; a displayer module configured to asynchronously display via the Internet the queue to each merchant having crafted a commercial offering; a reviser module configured to prompt the merchants having crafted a commercial offering to revise their offering; a storer module configured to store the Request Information, commercial offerings, and consumer request in computer readable memory in a database for future historical data tracking; and a referencer module configured to reference one or more of the Request Information, the commercial offering and the consumer request in generating Request Information exclusively associated with future consumer requests.

In some embodiments, the Request Information further comprises information added by the server, including one or more of the group comprising: the number of requests previously made by said consumer, the number of offers previously accepted by said consumer, an age range of the consumer, dollar amounts spent in response to previous commercial offerings by said consumer, number of previous visits of said consumer to the merchant, and the frequency of visits of said consumer to other merchants in the marketing network by said consumer.

In other embodiments, the system further comprises an acceptor module configured to prompt the consumer to accept a commercial offering from the queue upon reaching the expiration date.

The system may further comprise: a demerit module configured to assess demerits against merchants who do not respond to consumer requests before the expiration date; and a penalizing module configured to inversely rank commercial offerings shown in the queue by merchants in accordance with the offering merchant's respective number of demerits.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a data-entity relationship diagram illustrating one embodiment of a system for relaying commercial offerings from select merchants to select consumers in accordance with the present invention;

FIG. 2 is a Booch relationship diagram illustrating the interrelationships and organization of data created by the operations and modules of the present invention;

FIG. 3 is a second data-entity relationship diagram illustrating one embodiment of a system for relaying commercial offerings from select merchants to select consumers in accordance with the present invention;

FIG. 4 is a block diagram illustrating one embodiment of a computer system which inter-connects multiple parties in an interactive negotiative environment for relaying commercial offerings from select merchants to select consumers in accordance with the present invention;

FIG. 5 is a flowchart illustrating method steps of the present invention, including steps which may be performed for relaying commercial offerings from select merchants to select consumers in accordance with the present invention;

FIG. 6 is a flowchart illustrating method steps of the present invention, including steps which may be performed for relaying commercial offerings from select merchants to select consumers in accordance with the present invention;

FIG. 7 is a virtual layout diagram of a browser display showing the queue in accordance with one embodiment of the present invention;

FIG. 8A is a layout of virtual controls on a browser of a smart phone manipulated by one embodiment of the present invention;

FIG. 8B is a second layout of virtual controls on a browser of a smart phone manipulated by one embodiment of the present invention;

FIG. 8C is a third layout of virtual controls on a browser of a smart phone manipulated by one embodiment of the present invention;

FIG. 8D is a fourth layout of virtual controls on a browser of a smart phone manipulated by one embodiment of the present invention;

FIG. 8E is a fifth layout of virtual controls on a browser of a smart phone manipulated by one embodiment of the present invention; and

FIG. 8F is a fifth layout of virtual controls on a browser of a smart phone manipulated by one embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, modules, components, and so forth. In other instances, well-known steps or operations are not shown or described in detail to avoid obscuring aspects of the invention. The system modules recited in the claims may be configured to impart the recited functionality to an apparatus as well.

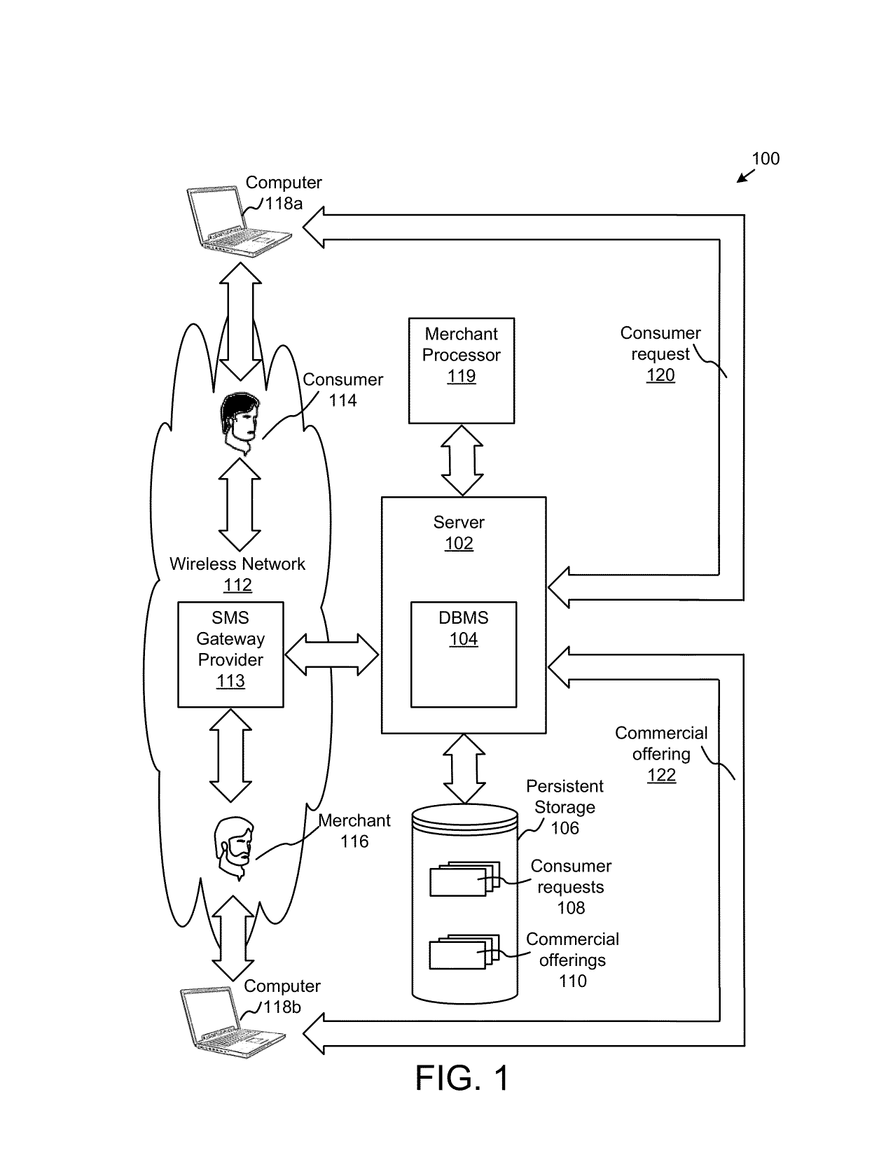

FIG. 1 is a data-entity relationship diagram illustrating one embodiment of a system for relaying commercial offerings from select merchants to select consumers in accordance with the present invention. The system 100 comprises a server 102, a database management system (DBMS) 104, persistent storage 106, stored consumer requests 108, stored commercial offerings 110, a wireless network 112, an SMS gateway provider 113, a consumer 114, a merchant 116, a computer 118a, a computer 118b, a merchant processor 119, a consumer request 120, and a commercial offering 122.

Typically, the server 102 comprises one or more central processing units executing software and/or firmware to control and manage the other components within the system 100. In one embodiment, the server 102 comprises hardware and/or software more commonly referred to as a Multiple Virtual Storage (MVS), OS/390, zSeries/Operating System (z/OS), UNIX, Linux, or Windows system 100.

The server may comprise a server cluster with firewalls, load balancer, and database servers having Apache® and/or other software applications well-known to those of skill in the art. The server 102, in the shown embodiment, comprises a database management system (DBMS) 104 or relational database management system (RDBMS), such as Oracle, MySQL, SQL, FireBird, IBM DB2®, or the like.

The server 102 is in logical communication with one or more consumers 114 and one or more merchants 116 through a networked environment 112, such as local area network (LAN) or wide area network (WAN). The server 102 may communicate with consumers 114 and merchants 116, sending queues, consumer requests 120, and commercial offerings 122, using variations of the Simple Mail Transfer Protocol (SMTP), Internet Message Access Protocol (IMAP), Post Office Protocol (POP), or other protocols well-known to those of skill in the art.

The computers 118a-b may comprise smart phones which, internally or externally, may comprise an Interactive Voice Response (IVR), which recognizes natural voice communication or DTMF keypad input.

In the present invention, the server 102 routes information between consumers 114 and merchants 116. The server 102 is in logical communication with the computer 118a-b. The server 102 is in logical communication via the Internet 112 with the cellular phones 118a-b of potential consumers 114, or through other personal DPDs such as laptops, Palm Pilots®, digital cameras, and the like.

In the present invention, as further described in detail below, consumers 114 create consumer requests 120 on their computers 118 which they relay to the server 102. These consumer requests 120 comprise information about commercial retail offers which the consumer 114 would like to receive from merchants 116. The server 102 facilitates a real-time negotiation between the consumer 114 and the merchant 116.

In some embodiments, the server 102 collects payments from consumers 114 redeeming commercial offerings 122 which they have accepted, then remunerates the merchant 116 making the commercial offering 122 in accordance with a predetermined payment schedule mutually agreed upon by the merchant 116 and a legal entity managing the server 102.

The consumers 114 may comprise any person, company or organization that is potentially a customer of another person, company or organization. The consumers 114 are incorporated into a marketing network comprising merchants 116 and consumers 114 who have registered with the server 102. For the purposes of this patent, the terms “incorporate” and “incorporation” denote the act of formally enrolling a consumer 114 or merchant 116 into the marketing network. Consumers 114 and merchants 116 become incorporated when they create accounts with the server 102 by uploading personal identifying information, including one or more of age, income, address, email address, telephone number, school attendance, consumer interests, product offerings, purchasing practices, credit rating, education level, pricing, and the like. In typical embodiments, the registration takes place via a browser, but may also be sent to the server 102 using programs well-known to those of skill in the art, such Microsoft Outlook, Thunderbird, Yahoo! Mail, and the like.

Like the consumers 114, the merchants 116 may comprise any person, company or organization that is potentially a merchant of another person, company or organization such as the consumers 114. The merchants 116 market a consumer product, service or business opportunity. The consumer product may comprise any valuable item which can be purchased, tangible or intangible. Examples of consumer products may include food, housing, electronics, books, gifts, digital media, guns, lodging, office supplies, legal services, medical services, insurance, construction contractors, or the like.

The merchants 116 are incorporated and allowed to receive and respond to consumer requests 120 originating with one or more consumers 114 and sent via the wireless network 112 to the merchant 116.

The computers 118a-b may comprise any system, apparatus or computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

Consumer requests 120 are stored in persistent storage 106 in a consumer requests 108 database file. The commercial offerings 110 are likewise stored in computer readable memory 106 in a commercial offerings 110 database file.

The merchant processor 119 is known to those of skill in the art, and may comprise a processor such as Elavon®, PayPal®, or the like.

The SMS gateway provider 114 relays short messages between the server 102 and/or one or more consumers 114 and/or one or more merchants 116.

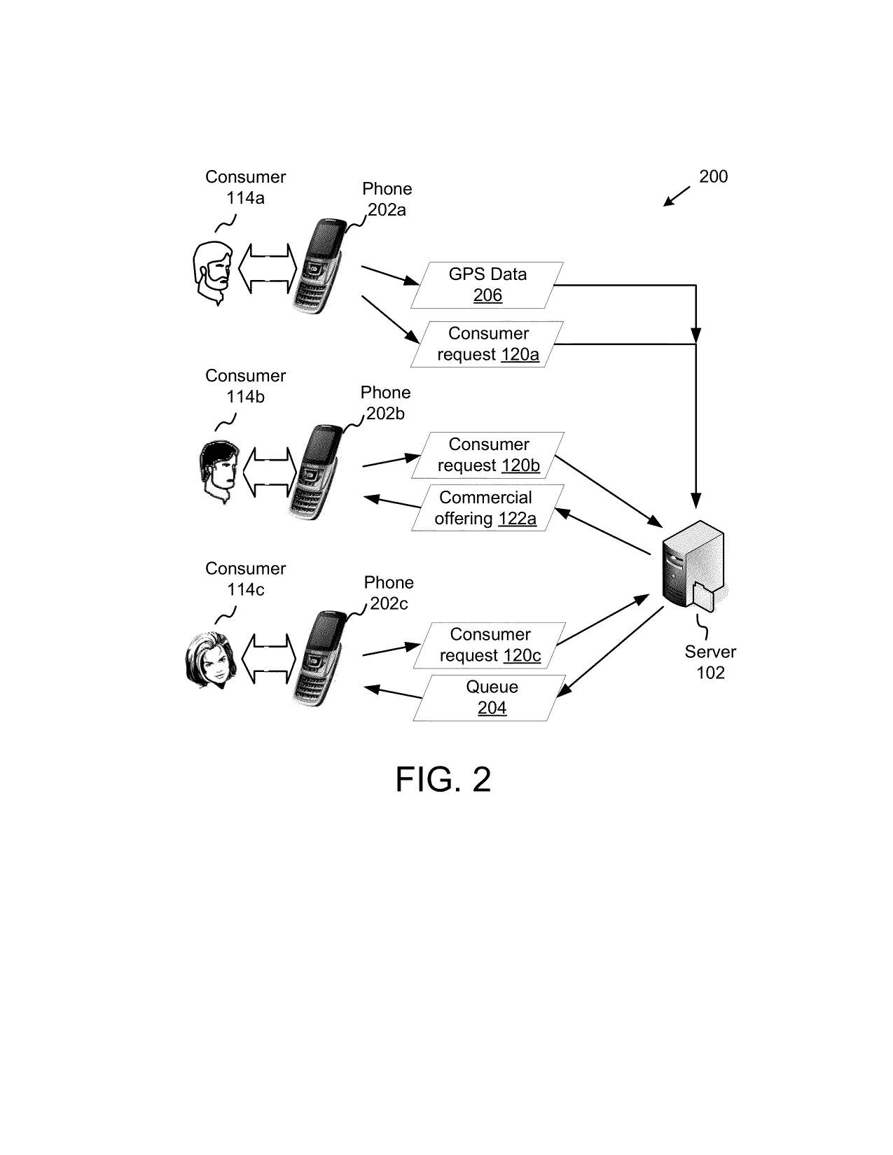

FIG. 2 is a block diagram illustrating one embodiment of a computer system 200 that inter-connects multiple parties in an interactive negotiative environment for relaying commercial offerings from select merchants to select consumers in accordance with the present invention. The system 200 comprises consumers 114a-c, phones 202a-c, a server 102, GPS data 206, a consumer request 120a, a consumer request 120b, a consumer request 120c, a commercial offering 122a, and a queue 204.

The legal entity managing the server 102 may comprise any individual, organization, entity, or combination thereof, tasked with selling, marketing, or negotiating retail offers between or for other third-parties. The legal entity may also comprise a system or computer program running on one or more data processing devices (DPDs).

In the shown embodiment, three consumers 114a-c are in communication with the server 102 using phones 202a-b. These consumers 114a-c have been incorporated into the marketing network. Consumer 114a creates a consumer request 120a which comprises information about a commercial offering 122 which the consumer 114a would like to receive. The consumer request 120a may comprise information characterizing the desired commercial offering, including a budget, a defined period of time within which the consumer would like to receive a response from a merchant, an anticipated time of arrival of the consumer 114 to the retail front of merchant 116 responding to the consumer request. This information form the Request Information.

In various embodiments of the present invention, the consumer 114a may interface with the server 102 on behalf of a subgroup of consumers 114 with whom the consumer 114a is acquainted. The consumer 114a may identify other consumers 114 in the marketing network who are interested in making a common purchase from a merchant 116, such as a dinner at a fine dining restaurant where they wish to be collectively seated. This group of common acquainted consumers 114 identified by the consumer 114a comprises a subgroup.

The consumer request 120a generated by the consumer 114a is forwarded to the server 102 and relayed along with other consumers requests to one or more merchants 116. In some embodiments, the consumer request 114a is relayed in a queue 204 with other consumer requests 114, such as request 120b and/or request 120c. In other embodiments, the consumer requests are relayed asynchronously to the merchants 116 who the server 102 identifies as satisfying a category specification in the Request Information and/or a subcategory specification in the Request Information.

In some embodiments, the category specification may be indicative of the type of merchant 116 with whom the consumer 114 is interested in negotiating, such as a restaurant, attorney, doctor, and the like. The subcategories comprise one or more subcategories within the category defining the merchant 116 with whom the consumer 114 creating the consumer request 120 is interested in negotiating with, such as Italian cuisine, American cuisine, Japanese cuisine, Chinese cuisine, or divorce attorneys, patent attorneys, corporate attorneys, and the like.

The characteristics of the consumer request may comprise one or more characteristics from the group consisting of food, entertainment, health/beauty, electronics, hotel/lodging accommodations, air travel, and professional services. The sub-characteristics may comprise one or more characteristics from the group consisting of a price request, a discount rate request, a geographic proximity request, a time in business threshold, a ranking of a third-party organization request, a ranking of consumers in the marketing network request, a response expiration date, a fastest historical response time to previous consumer requests, and a highest level of availability.

Merchants 116 satisfying the category and/or subcategory requests receive the consumer request 114a and/or the queue 204. These merchants 116 are given a chance to accept, deny, or make a counteroffer to the consumer 114a in response to receiving the consumer request 120.

If a merchant 116 accepts the consumer request 120, this merchant 116 is committing legally to offer the consumer product requested in the Request Information to the consumer on the terms outlined in the Request Information. The consumer 114a must then redeem the commercial offering by spending money at the merchant's 116 location in accordance with the terms accepted by the consumer 114 in the commercial offering 122.

The merchant 116 is given the chance, in some embodiments, to submit a counteroffer to the consumer 114a. The merchant 116 may counteroffer a higher price, a small discount rate, a different arrival time, and the like. The counteroffer submitted by the merchant 116 may comprise a commercial offering 122. This commercial offering may contain terms proposed to the consumer 114 for acceptance. The terms collectively comprise the Offering Terms, and include one or more of a price, discount rate, period of time within which the commercial offering may be redeemed, a physical location for redemption, or other terms.

Pending consumer requests 120, from a plurality of consumers 114 in the marketing network are shown to the merchant 116 in a queue 204 relayed from the server 102 to the merchant 116. The queue 204 may rank, or order, the consumer requests 120 shown in the queue in accordance with the preferences of the merchant 116 to whom the queue is being relayed.

In some embodiments, the consumer requests 120 are ranked in the order in which they were created by the creating consumer 114. In other embodiments, the consumer requests are ranked in accordance with the discount rate being requested in the Request Information by the consumer 114.

The discount rate is the discount, as a percentage, that is being offered or requested off a listed retail price of the consumer product. For instance, the discount rate in a consumer request 120 in which a consumer was requesting 33% off the retail price of an entrée would be 33%. As the discount rate increases, therefore, the price of the consumer product decreases.

The merchants 116 may rank the queue in accordance with any piece of information in the Request Information. In some embodiments of the present invention, the consumer requests 120 in the queue 204 are ranking in accordance with creating consumer's 114 geographic proximity to the merchant 116.

GPS data 206 indicating the consumer's 114 geographic location and/or direction of travel is acquired by the server 102, gather from the service provider providing cellular telephone service to the consumer 114. This GPS data 206 is serves a variety of functions in the present invention as further outlined below.

Like the queue 204, commercial offerings 122 coming from merchants 116 may be prioritized in a queue for the consumers 114. The consumers 114 may prioritize the commercial offerings 122 in accordance with a variety of criteria, including the offering merchant's time in business, the largest discount rate offered by a merchant, the lowest price, the closes, and the like.

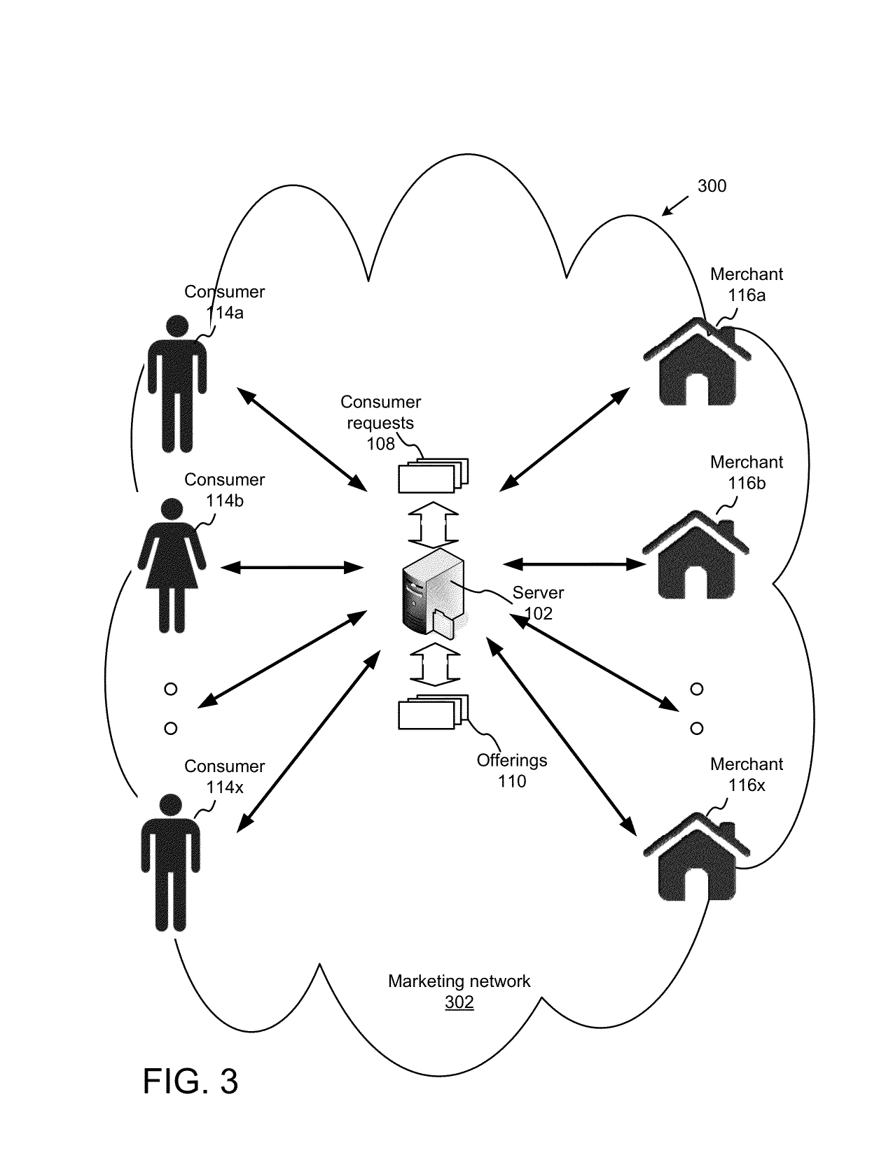

FIG. 3 is a system resources chart illustrating one embodiment of a system 300 that relays commercial offerings from select merchants to select consumers in accordance with the present invention. The system 300 comprises consumers 114a-x, merchants 116a-x, a server 102, stored consumer requests 108, commercial offerings 110, and a marketing network 302.

All of the merchants 116a-x and consumers 114a-x are incorporated into the marketing network 302. Consumer requests 120 are stored in a computer readable database file 108, while commercial offerings 122 are stored in a computer readable database file 110.

Historical data is also stored in computer readable memory, including all commercial offerings 122 and all consumer requests 120, as well as consumer 114 responses to commercial offerings 122 (e.g. acceptance, rejection, and/redemption, and the like). A consumer 114 may simply ignore an offer made by a merchant, and the consumer's 114 choice to ignore the commercial offering may be stored in computer readable memory.

In various embodiments of the present invention, the merchants 116 may set criteria for automatically accepting consumer requests 120 which are forwarded to the merchants 116 by the system 300 and/or computer program product implementing the present invention. The merchants may set a price below which consumer requests 120 are automatically rejected, or a price above which consumer offers are automatically accepted. Merchants 116 may do the same for discount rates and geographic distances between consumers 114 and the respective merchants 116.

In various embodiments of the present invention, merchants 116 who have smaller percentages of commercial offerings 122 redeemed than other merchants may have their commercial offerings 122 moved to the top of an offering queue comprising all commercial offerings 122 from all merchants 116 made in response to a consumer request 120. This offering queue, or queue, may be forwarded as it is generated to consumers 114, synchronously or asynchronously.

In other embodiments of the present invention, consumers 114 who do not redeem a high enough percentage of commercial offerings 122 accepted, or consumer requests 120 accepted, are penalized by having discount rates and/or prices in commercial offerings 122 automatically adjusted.

The marketing network 302, as discussed above, is a virtual network of merchants 116 and consumers 114 who have chose to incorporate for the purpose of negotiating with one another for consumer products.

The server 102, merchants 116a-x, consumers 114a-x, consumer requests 108, and commercial offerings are all substantially described above in relation to FIGS. 1-2.

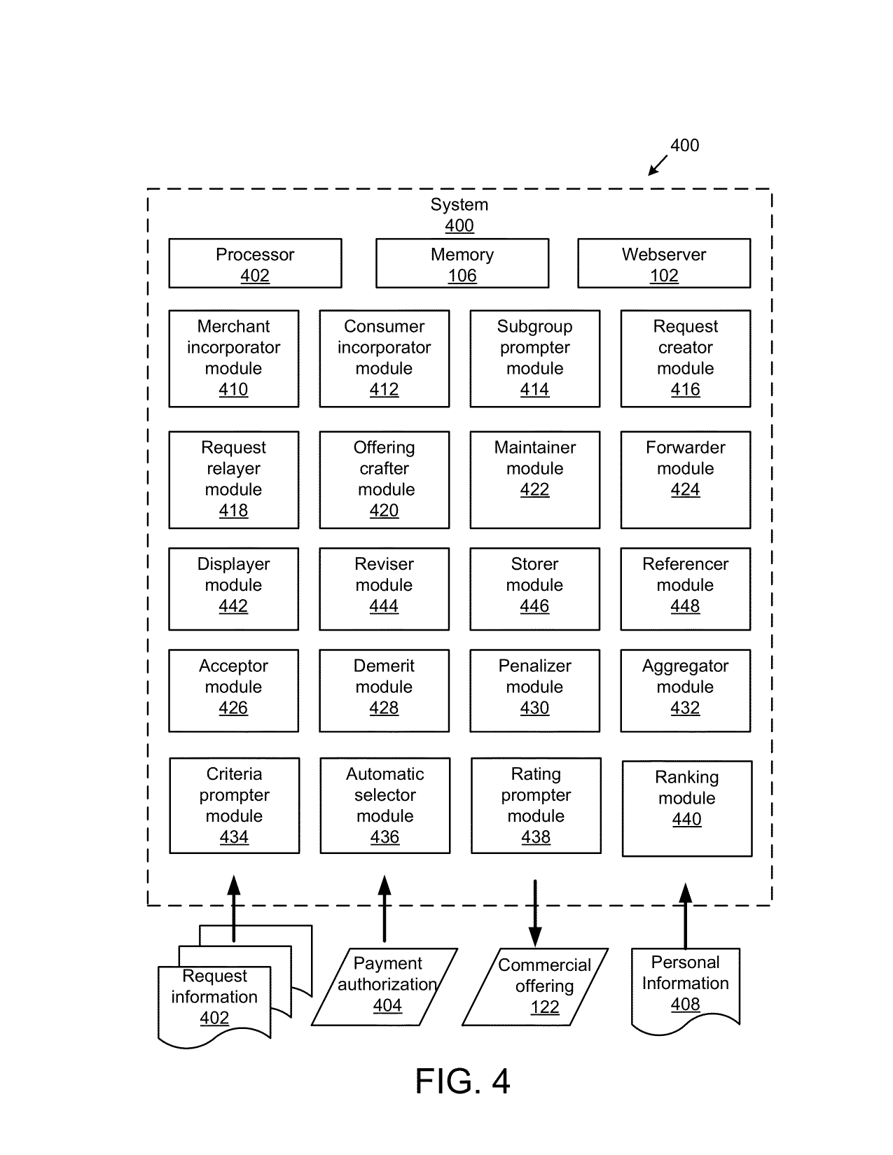

FIG. 4 is a block diagram illustrating one embodiment of a computer system which inter-connects multiple parties in an interactive negotiative environment for relaying commercial offerings from select merchants to select consumers in accordance with the present invention. The system 400 comprises a processor 402, memory 106, a webserver 102, a merchant incorporator module 410, a consumer incorporator module 412, a subgroup prompter module 414, a request creator module 416, a request relayer module 418, an offering crafter module 420, a maintainer module 422, a forwarder module 424, a displayer module 442, a reviser module 444, a storer module 446, a referencer module 448, an acceptor module 426, a demerit module 428, a penalizer module 430, an aggregator module 432, a criteria prompter module 434, an automatic selector module 436, a rating prompter module 438, and a ranking module 440.

The merchant incorporator module 410 is configured to incorporate a plurality of merchants 116 into a marketing network 302 by storing each respective merchant's name, physical address, age, banking information, telephone number, and email address in persistent computer readable memory 106. A virtual account is created for each merchant 116 incorporated into the marketing network 302.

The consumer incorporator module 412 is configured to incorporate a plurality of consumers 114 into a marketing network 302 by storing each respective consumer's 114 cellular telephone number, name, and email address in persistent computer readable memory. The consumer incorporator module 412 may also store consumer 114 banking information.

The subgroup prompter module 414 is configured to prompt a consumer 114 to create a virtual subgroup of consumers, the virtual subgroup of consumers comprising the names of a plurality of commonly acquainted consumers 114 interested in collectively purchasing a commercial product 120 from a single merchant in the marketing network, such as lodging, housing, cars, travel or food services (e.g. a dinner party).

The request creator module 416 may be configured to perform a variety of functions, including collecting principal characteristics of a commercial offering the consumer is interested in receiving on behalf of a subgroup of consumers; ranking sub-characteristics of the commercial offering which said consumer values most highly; and accept an expiration date for the consumer request and one or more pieces of information (this information collectively comprising the “Request Information”) from the group consisting of: a subgroup size, a subgroup budget, desired response time, and anticipated time of arrival of the subgroup.

The request relayer module 418 is configured to electronically relay the consumer request 120 and Request Information to a plurality of merchants 116 in the marketing network 302. The offering crafter module 420 may be configured to craft a commercial offering 122 in response to the consumer request 120 before the expiration date. In some embodiments, the offering crafter module 420 automatically crafts the commercial offering 122. In other embodiments, the offering crafter module 420 may prompt the merchant 116 to input values to be used in crafting the commercial offering 122.

The merchant uploader module may be configured to upload the commercial offering to a server 102 managing the marketing network in response to receiving the Request Information. The offering forwarder module 424 may be configured to forward commercial offerings 122 crafted by a plurality of merchants 116 and uploaded to the server 102, then to said consumer 114.

The maintainer module 422 may be configured to maintain a queue of commercial offerings 122 made to said consumer 114 by all merchants 116 in the marketing network 302 until the expiration date.

The forwarder module 424 may be configured to forward all commercial offerings 122 received in response to the consumer request 120 to one of said consumer's smart phone, the server 102 and said consumer's personal computer 118.

The displayer module 442 is configured to asynchronously display via the Internet the queue to each merchant having crafted a commercial offering 122. The queue may also be displayed synchronously. The reviser module 444 is configured to prompt the merchants 116 having crafted a commercial offering 122 to revise their offering.

The storer module 446 is configured to store the Request Information, commercial offerings 122, and consumer request 120 in computer readable memory 106 in a database for future historical data tracking. The referencer module 448 may be configured to reference one or more of the Request Information, the commercial offering 122 and the consumer request 120 in generating Request Information exclusively associated with future consumer requests 120.

The Request Information may comprise information added by the server 102, including one or more of the number of requests previously made by said consumer, the number of offers previously accepted by said consumer, an age range of the consumer, dollar amounts spent in response to previous commercial offerings by said consumer, number of previous visits of said consumer to the merchant, and the frequency of visits of said consumer to other merchants in the marketing network by said consumer.

The acceptor module 426 is configured to prompt the consumer 114 to accept a commercial offering 116 from the queue upon reaching the expiration date. The demerit module 428 may be configured to assess demerits against merchants 116 who do not respond to consumer requests 120 before the expiration date; and the penalizer module 430 may be configured to inversely rank commercial offerings 122 shown in the queue by merchants 116 in accordance with the offering merchant's 116 respective number of demerits.

The automatic selector module 436 is configured to automatically select an acceptance from the merchant satisfying one of the criteria from the group consisting of: highest rated merchant by a third-party, highest revenue grossing merchant, highest paying merchant to a legal entity controlling the server.

The criteria prompter module 434 may be configured to prompt a merchant to set criteria for automatically accepting consumer requests comprising Request Information exceeding one or more thresholds defined by the merchant, the thresholds from the group consisting of: price, number of previous purchases by the consumer, the consumer's historical average spending, the consumer's distance geographically from the merchant, the consumer's budget, and a rating ascribed to the consumer by one of a system and computer program product effectuating relay of the consumer offer.

The system 400 comprises a processor 402, a server 102, computer readable storage 106, and the following modules: merchant incorporator module, consumer incorporator module, subgroup prompter module, request creator module, request relayer module, offering crafter module, maintainer module, forwarder module, displayer module, reviser module, storer module, reference module, acceptor module, demerit module, penalizer module, and an aggregating module.

The files 108, 110 may be queried with dynamic database queries comprising keywords and/or logical bitwise operations that the indexing server 102 infers were intended such as NOR, OR, XOR, AND, NAND, and the like, as well as other information.

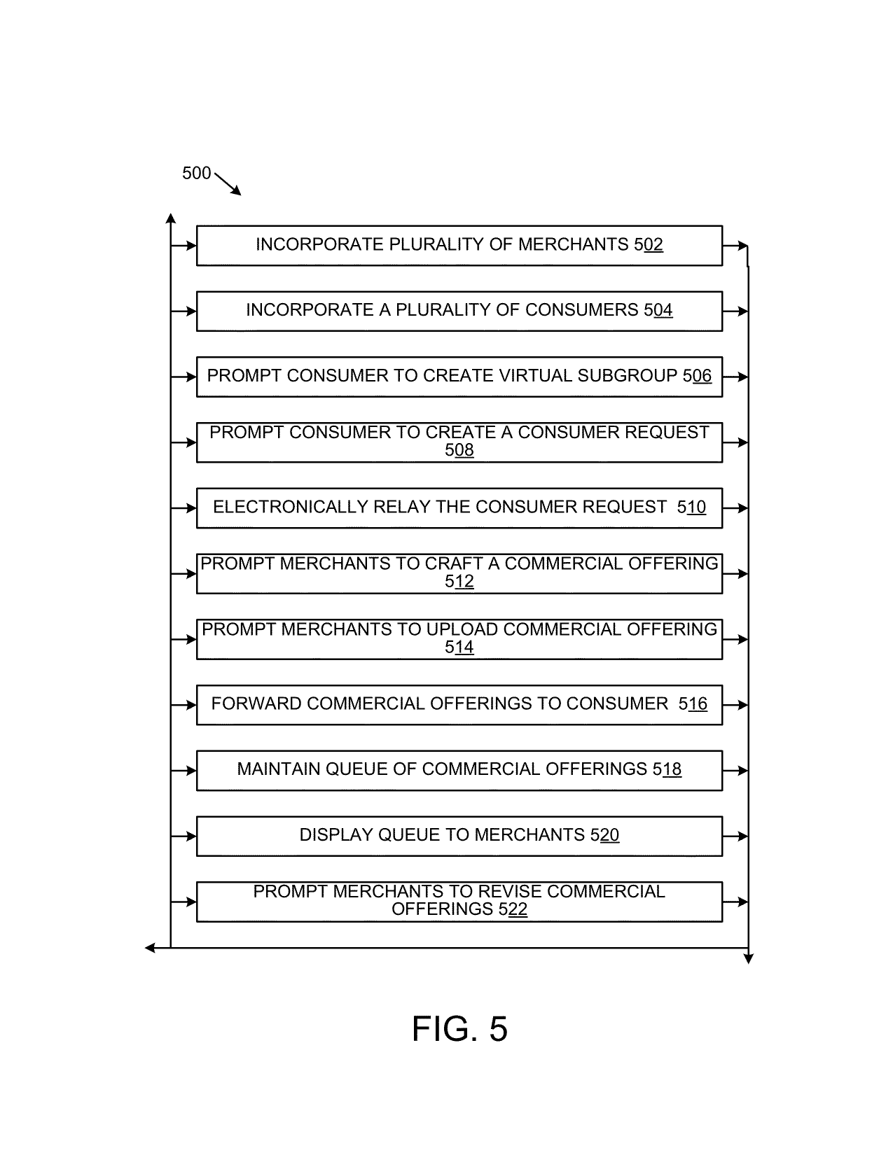

FIG. 5 is a flowchart illustrating a method 500 of the present invention, including steps which may be performed for relaying commercial offerings from select merchants to select consumers in accordance with the present invention.

The steps of method 500 may be executed in any order as shown. The method 500 begins with consumers 114 being incorporated 502 into the marketing network 302. Merchants are likewise incorporated 504. The consumer 114 is prompted 506 to create a virtual subgroup of other consumers 114. In some embodiments, the consumers 114 in each virtual subgroup are shown the names and photographs of each other consumer 114. In some embodiments, the consumer 114 forming the subgroup if the spokesman or organizer of the group, who interacts with merchants 116 on behalf of the group. In those embodiments, the organizer creates consumer requests 120 which are uploaded to the server 102 and relayed in a queue to the merchants 116.

The consumer 114 creates 508 a consumer request 120. This consumer request may be created on a DPD such as smart phone 118. The consumer request comprises percentages, dates (including time), categories, subcategories, geographic distance limits, request discount rates, a credit rating, a budget, a requested lease term and/or other terms which the consumer 114 would like to see a merchant satisfying the category and subcategory specifications accept.

Merchants 116 in the marketing network satisfying these categories and subcategories are forwarded the consumer request 120. In some embodiments, the consumer request 120 is forwarded 510 in a queue, or the queue is asynchronously updated to include the consumer request 120.

Generally, merchants 116 view the updated the queues on a browser window on a DPD connected to the Internet, such as Explorer®, FireFox®, Chrome®, Safari® or the like.

Merchants 116 may accept the consumer request 120, or create a counteroffer called a commercial offering 122 with alternate term(s). These terms may consist of geographic proximity limits, a price, a discount rate, a lease term, a deposit, a minimum credit score, and a window of time.

The consumer requests are electronically relayed 510 to the merchants 116 by the server 102 and the method 500 proceeds as shown.

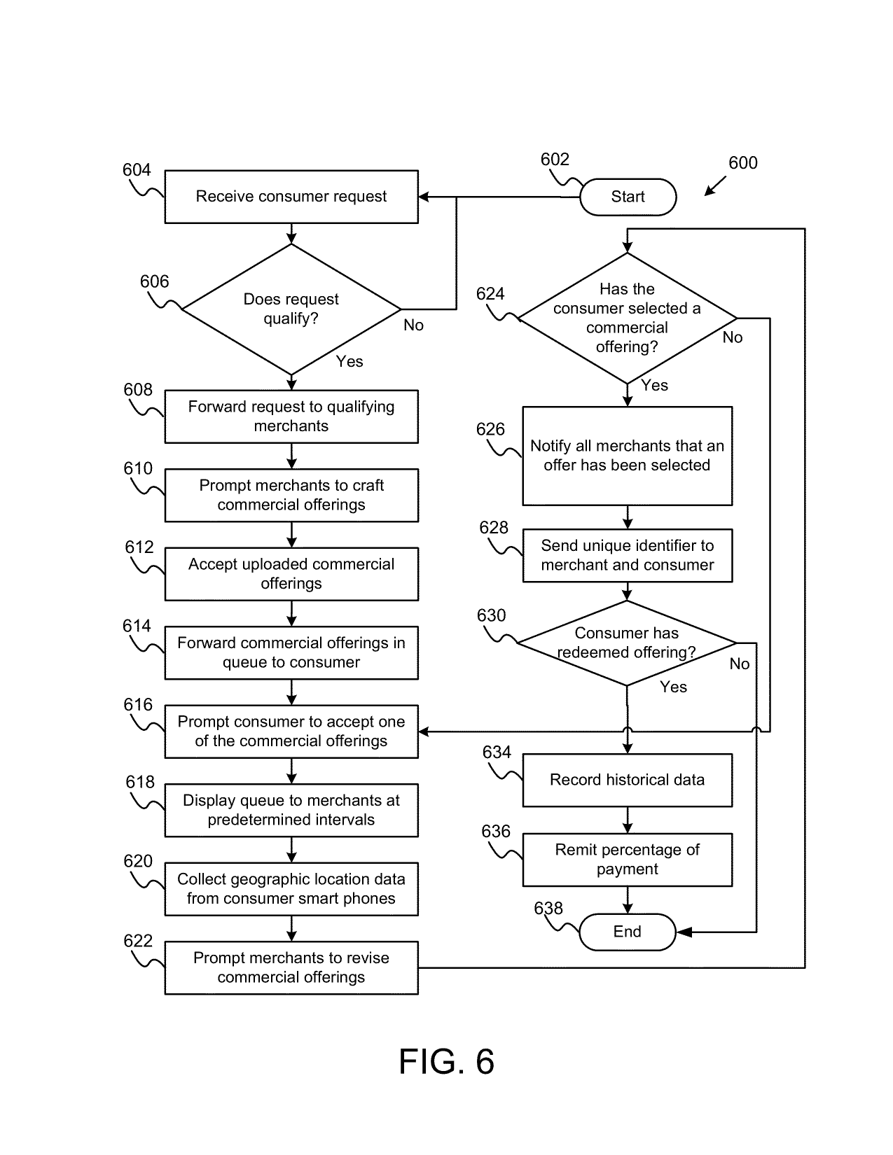

FIG. 6 is a flowchart illustrating a method 600 of the present invention, including steps which may be performed for relaying commercial offerings from select merchants to select consumers in accordance with the present invention.

The method 600 begins 602 when a consumer request 120 is received 602 from a consumer 114. A preliminary check is done to see if 604 the consumer request meets certain criteria, including whether or not there are any merchants 116 in the marketing network 302 which satisfy the category and subcategory specifications of the consumer 114 in the consumer request 114. In some embodiments, a check is also done to determine whether or not the merchants 116 are willing to entertain consumer requests 120 comprising price and/or discount rate values as low or high as those forming the consumer offer 120, as well as geographic proximity limits. Assuming that the consumer offer 120 satisfies these predetermined thresholds, the consumer offer 120 is forwarded 608 to qualifying merchants 116 and those merchants 116 are prompted 610 to create counteroffers to the consumers 114 in the form of commercial offerings 122.

In some embodiments, the merchants 116 can configure the server 102 to automatically make counteroffers 122 to consumers which comprise higher prices and/or lower discount rates, even in response to a consumer request 120 which otherwise would have been automatically accepted. This feature allows merchants 116 to maximize revenue and profits if they choose, even in response to an consumer request 120 that would otherwise be acceptable.

The commercial offering 122 crafted by the merchant 116 is uploaded 612 to the server 102, then stored in persistent memory 106, and forwarded 614 in a queue with other commercial offerings 122 from other merchants 116 to the consumer 114.

The consumer 114 is prompted 616 to accept one of the commercial offerings 122 in the queue. The same queue displayed to the consumer 114 may also be displayed 618 to the merchants 116 who have commercial offerings 122 in the queue 204. In some embodiments, the queue is only updated for the merchants 116 at periodic intervals of time, while in other embodiments, the queue is continuously updated asynchronously.

Geographic data is automatically collected 620 from the consumer's 114 cellular phone. In some embodiments, the consumer 114 has given legal permission to his/her cellular phone service provider to transmit this geographic information, collected by the service provider, to the server 102. In other embodiments, the cellular phone 118 of the consumer 114 collects GPS information at the phone and transmits this information to the server 102 via the Internet 112. The server may calculate or collective information about the direction and speed of travel of a consumer 114 on the move by references multiple instances of GPS location information over a given period of time. This GPS information, including speed and direction of travel, collectively comprises the GPS Information.

This GPS information is relayed to the merchants 116 who have commercial offerings 122 in the queue 204. Those merchants 116 are prompted 622 to revise their previous commercial offerings 122 in response to receiving the GPS Information. The updated commercial offerings 122 are forwarded to the consumer 114.

If 624 the consumer 114 has selected a commercial offering 122, than all merchants 116 is with commercial offerings 122 in the queue 204 are notified 626 that an offer has been selected. A unique password comprising numbers and/or letters is sent to both the consumer 114 accepting the commercial offering 122 and the merchant 116 creating the commercial offering 122. This unique password, or identifier, is used by the consumer 114 to identify himself when he arrives at the merchant's 116 location.

When the consumer 114 redeems the commercial offering 116, by spending money, the merchant 116 is required to note this and forward this information to the server 102 for storage 634 in persistent memory 106. The percentage of commercials offerings 122 which a consumer 114 redeems after acceptance may be used to reward or penalize the consumer 114 in future commercial offerings 122 by other merchants 116.

Finally, a percentage of the money collected from the consumer 114 is remitted to the legal entity by the merchant 116, or the legal entity remits a percentage of the money to the merchant 116. In some embodiments, both the merchant 116 and the consumer 114 are prompted by the server 102 to rank each other's service, patronage, professionalism, quality and/or the like after the commercial offerings 122 is redeemed.

In some embodiments of the present invention, merchants 116 receive electronic or physical statements originating with the server 102 which shown a detailed history of the commercial offerings 122 which the merchant 116 has crafted, and how those offers were treated by consumers 114 who received them, including whether the offers were accepted, ignored, rejected and/or redeemed. The electronic statement may contain hyperlinks to webpages with additional information online, and may be formatted as shown below:

| | | | | |
|---|---|---|---|---|
| | | | Com. | Money |
| Merchant | Time | Share | Paid | Kept |

DEALS WON

| | | | | | | |
|---|---|---|---|---|---|---|
| $10 worth of | B. Jones | 12:50 | $8.00 | 80% | $2.00 | Details |
| food for $28 | | | | | | |
| $20 worth of | A. Smith | 6:15 | $17.00 | 85% | $3.00 | Details |
| food for $35 | | | | | | |

DEALS LOST

| | | | | |
|---|---|---|---|---|
| $8 worth of | xxx | 11:40 | NA | Details |
| food for $12 | | | | |
| $14 worth of | xxx | 11:50 | NA | Details |
| food for $22 | | | | |
| $15 worth of | xxx | 12:30 | NA | Details |
| food for $23 | | | | |
| $20 worth of | xxx | 5:55 | NA | Details |
| food for $30 | | | | |
| $22 worth of | xxx | 6:30 | NA | Details |
| food for $34 | | | | |

In various embodiments of the present invention, merchants 116 receive these electronic statements only after participating in the marketing network for a predetermined period of time. In some embodiments, the merchants 116 receive statements that include not just details of the commercial offerings 122 which each respective merchant 116 has created, but also competing merchants 116 who likewise received identical consumer requests 120 from a consumer 114.

The statements may be relayed to merchants 116 with suggestions for improving commercial offering 122 acceptance in the future, the suggestions generated automatically by the server 102 after an analysis of historic data. Merchants 116 who take suggestions sent to them with their statements, may be rewarded by having their commercial offerings 122 featured in the future in the queue 204 relayed to consumers 114. The teachings of the present invention may also be applied to negotiations between landlords and tenants with regard to commercial or residential real estate leases.

In some embodiments, the merchants 116 are offered a hindsight simulation feature, in which the merchants 116 are given the option of adjusting the prices and/or discount rates in expired commercial offering 122 in a simulated environment to see if the adjusted commercial offering 122 would have been accepted, based on historical data, by the consumer 114 if the commercial offering 122 were so adjusted before expiration.

Consumers 114 likewise may receive electronic statements showing commercial offerings 122 made to the consumer 114 in response to consumer requests 120.

| Number of times this merchant has | | |
|---|---|---|
| been in your deal dispatches | Recent Offer | |
| over the past “x” weeks: | Improvements | |
| 4 | ABC Burgers | none |
| 3 | XYZ Tacos | none |
| 3 | Kim's Korean | **** |
| 3 | 123 Pizza | none |
| 2 | 789 Subs | * |
| 2 | ABC Mexican | none |

The electronic statements received by consumers 114 may be configured by the consumer 114 to show the number of times a merchant 116 has responded to consumer requests 120 by the consumer 114 or by other consumers 114. The electronic statement may show the number of times a merchant 116 has improved their offer in response to a request by the consumer 114 that the merchant do so.

In some embodiments of the present invention, the consumer 114 may accept more than one commercial offering 122 from the queue 204, after which time the selected merchants 116 originating the selected commercial offerings 122 are put into a successive queue in which non-selected merchants 116 have been eliminated. The selected merchants 116 are then notified of their selection and again given a chance to revise their commercial offerings 122 sent in the queue 204.

Consumers 114 may reconfigure the queue 204 to see only merchants 116 whom they have rated positively before, or to exclusively feature merchants 116 whom they have expressed an interest in visiting before. Consumers 114 may also reconfigure their view of the queue to show only merchants 116 who have revised their commercial offerings 122 since an earlier configuration event (the configuration event being an earlier reconfiguration of the queue 204).

In other embodiments, the consumer 114 may craft a consumer request 120 which does include categories or subcategories, but which consumer request 120 the consumer 114 relays directly to select merchants 116.

In still further embodiments, the consumers 114 may compare the prices and/or discount rate of a commercial offering 122 received from a merchants 116 to the price and/or discount rate previously offered in previous commercial offerings 122 by the merchant 116 to see if terms from the merchant 116 have improved or not.

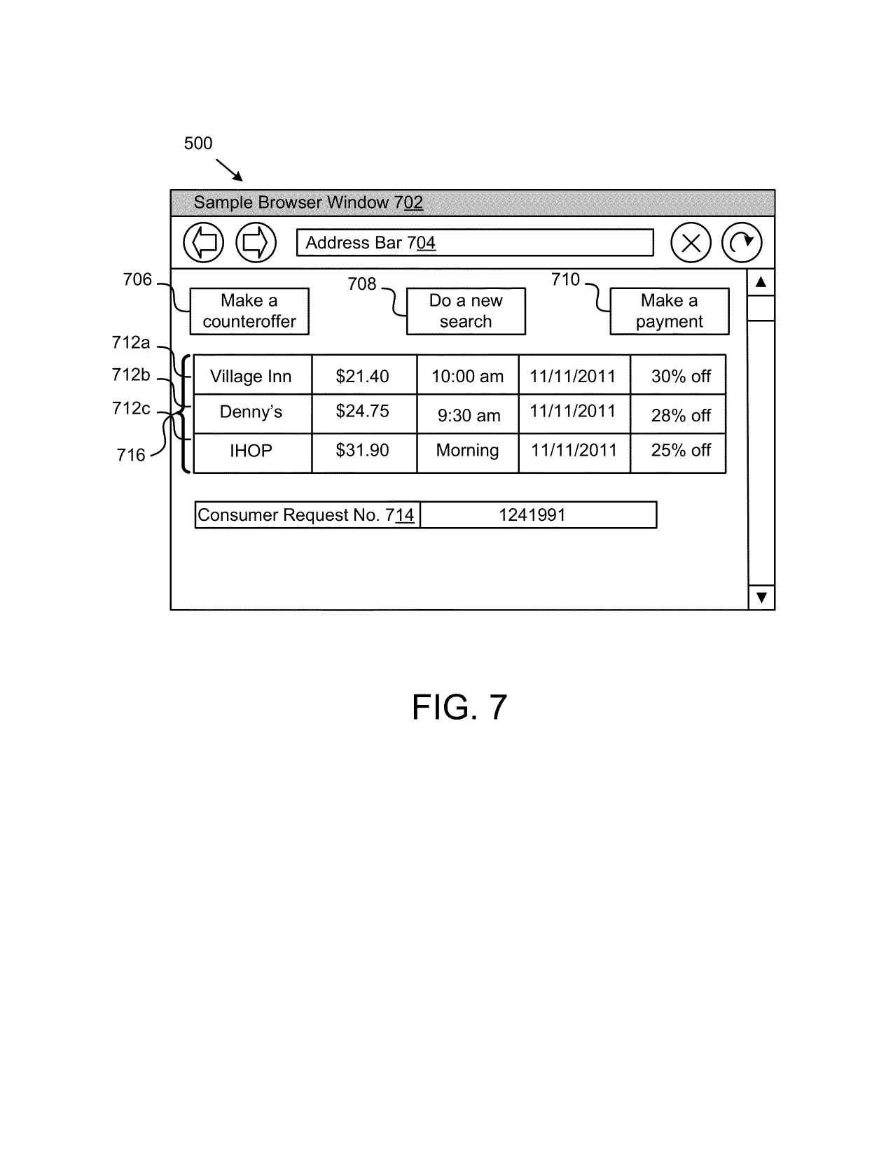

FIG. 7A is a layout of virtual controls on a browser of a smart phone manipulated by one embodiment of the present invention.

As shown in this embodiment, a URL address 704 is displayed in the browser window 702. The browser window comprises virtual buttons and controls for interfacing with the server 102. Button 706 allows a merchant 116 or a consumer 114 to make a counter offering 122. Button 708 allows a merchant to search for consumers 114 within a geographic area. Button 710 allows a consumer 114 to make a payment for an accepted commercial offering. In some embodiments of the present invention, the consumer 114 must make a payment upon accepting a commercial offering 122. In other embodiments, the consumer 114 makes the payment upon arrival at the merchant's 116 place of business.

The queue 204 is display in a field 716 in the browser window 702. The queue 204 comprises the names of merchants 116 who have made commercial offerings 122 in response to a consumer request 120. The queue 204 comprises the price being offered by each merchant 116 on a consumer product 102, as well as time by which the offering 122 must be redeemed, a date the offering was made, and discount rate on the consumer product underlying the offering 122.

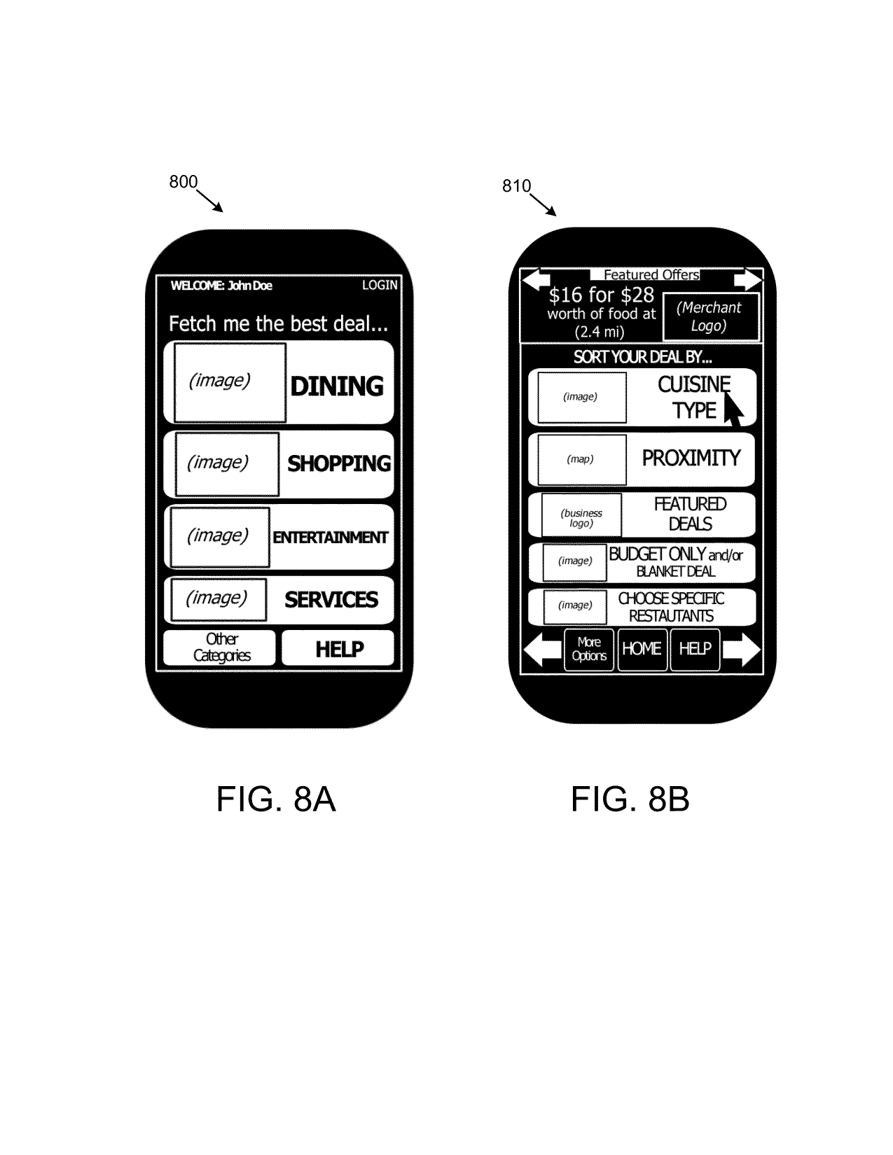

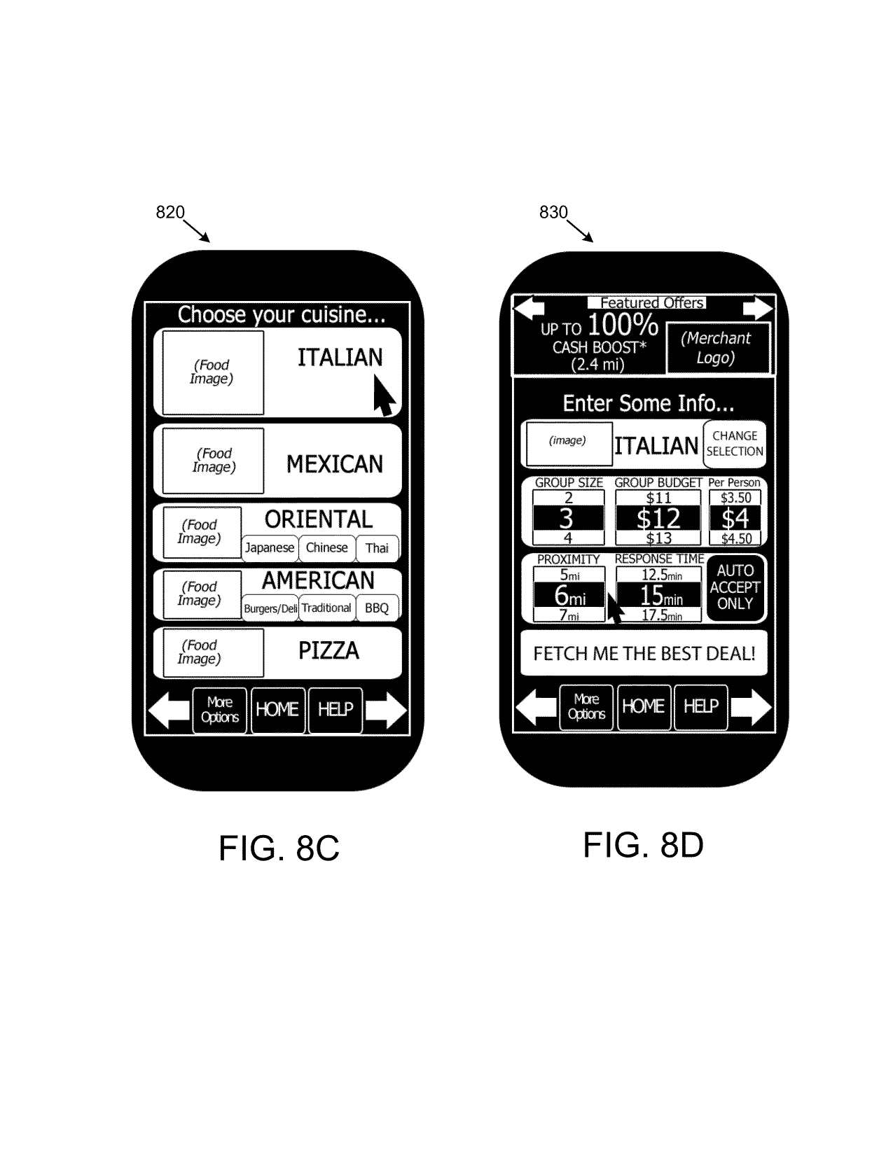

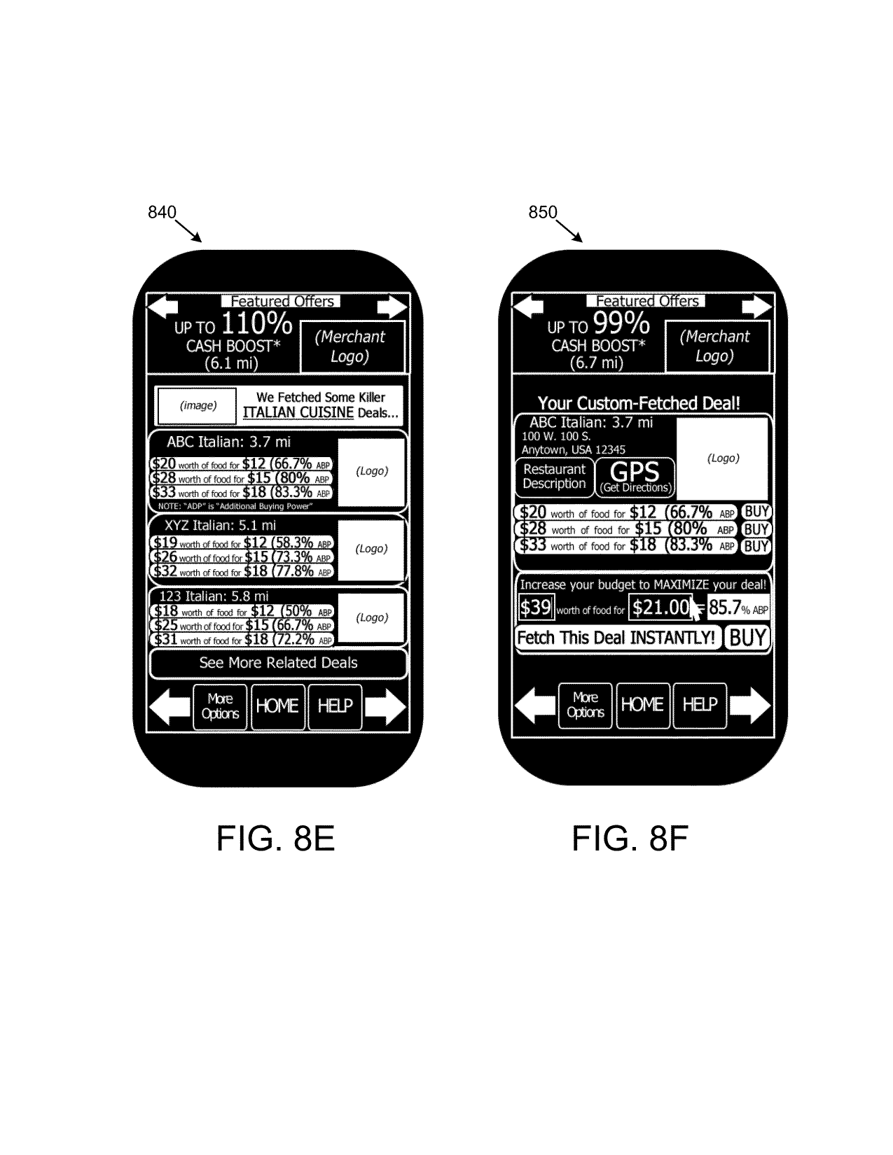

FIG. 8A is a layout 800 of virtual controls on a browser of a smart phone manipulated by one embodiment of the present invention. From the display 800, a consumer 114 begins to form a consumer request 120. The consumer 114 first picks a category within which the consumer request 120 will fall from those shown.

FIG. 8B is a second layout 810 of virtual controls on a browser of a smart phone manipulated by one embodiment of the present invention. From the display 810, a consumer 114 picks a subcategory within which the consumer request 120 will fall from those shown. In the shown embodiment, the consumer 114 has pickled the Dining category previously and is given the option of picking various subcategories, including a cuisine type, a geographic proximity limit surrounding the consumer 114 of merchants 116 receiving the consumer request 120, and other shown subcategories. The consumer 114 may see featured deals, which are commercial offerings 122 made sua sponte by merchants 116 not in response to a consumer request 120, which featured deals are open to all consumers 114 within the marketing network 302 within a set geographic radius.

FIG. 8C is a third layout 820 of virtual controls on a browser of a smart phone manipulated by one embodiment of the present invention. In this instance, the consumer 114 has picked cuisine type as a subcategory, and must now select the type of cuisine desired from the shown list.

FIG. 8D is a fourth layout 830 of virtual controls on a browser of a smart phone manipulated by one embodiment of the present invention. In this embodiment, the consumer 114 has picked Italian as the cuisine type, and must now specify other value for the Request Information, including an overall budget, a per person budget, a group size, and a geographic proximity limit. The consumer 114 also specifies a deadline, or response time, within which all merchants 116 receiving the consumer request 120 must respond to it.

FIG. 8E is a fifth layout 840 of virtual controls on a browser of a smart phone manipulated by one embodiment of the present invention. The display 840 follows selection of a virtual control on display 830. The consumer 114 is now shown the queue 204 as it is populated asynchronously by merchants 116 receiving the consumer request. Three merchants 116 have now responded to the consumer request 120 with commercial offerings 122 made in response to the consumer request 120. One of these offers is featured above the queue 204, and blinks in this embodiment.

FIG. 8F is a sixth layout 850 of virtual controls on a browser of a smart phone manipulated by one embodiment of the present invention. In this display 850, the consumer 114 has now accepted the commercial offering 122 featured by the Italian restaurant, and is given details about the commercial offering 122 which the consumer 114 has accepted as shown. The consumer 114 has option of getting directions to the Italian restaurant on the consumer's 114 phone 118. The consumer 114 is also provided with various other options commercial offers related to the commercial offering 122, and given the chance to receive additional discounts on the commercial offering 122 should the consumer 114 decide to accept the additional commercial offers.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having computer usable program code executable to perform operations for relaying commercial offerings from select merchants to select consumers, the operations of the computer program product comprising:
incorporating a plurality of merchants into a marketing network by storing each respective merchant's name, physical address, telephone number, and email address in persistent computer readable memory;
incorporating a plurality of consumers into a marketing network by storing each respective consumer's cellular telephone number, name, age, and email address in persistent computer readable memory;
prompting a consumer to create a virtual subgroup of consumers, the virtual subgroup of consumers comprising the names of a plurality of commonly acquainted consumers interested in collectively purchasing a consumer product from a single merchant in the marketing network;
prompting a consumer to create a consumer request by:
identifying principal characteristics of a consumer product the consumer is interested in receiving on behalf of one or more of himself and the subgroup of consumers;
prompting said consumer to rank sub-characteristics of the consumer product which said consumer values most highly;
prompting said consumer to input an expiration date for the consumer request and one or more pieces of information (this information collectively comprising the “Request Information”) from the group consisting of: a subgroup size, a budget, a desired response deadline, and anticipated time of arrival of the subgroup;
electronically relaying the consumer request and Request Information to a plurality of merchants in the marketing network;
prompting a plurality of merchants to craft a commercial offering in response to receiving the consumer request before the expiration date;
prompting each receiving merchant to upload the commercial offering to a server managing the marketing network in response to receiving the consumer request and Request Information;
forwarding commercial offerings crafted by a plurality of merchants and uploaded to the server to said consumer;
maintaining a queue of commercial offerings forwarded to said consumer by all merchants in the marketing until the expiration date;
forwarding all commercial offerings received in response to the consumer request to one of said consumer's smart phone and said consumer's personal computer;
asynchronously displaying via the Internet the queue to each merchant having crafted a commercial offering;
prompting the merchants having crafted a commercial offering to revise their offering;
storing the Request Information, commercial offerings, and consumer requests in computer readable memory in a database for future historical data tracking; and
referencing one or more of the Request Information, the commercial offering and the consumer request in generating Request Information exclusively associated with future consumer requests.

2. The computer program product of claim 1, wherein the sub-characteristics comprise one or more characteristics from the group consisting of a price request, a discount rate request, a geographic proximity request, a time in business threshold, a ranking of a third-party organization request, a ranking of consumers in the marketing network request, a response expiration date, a fastest historical response time to previous consumer requests, and a highest level of availability.

3. The computer program product of claim 2, further comprising organizing the commercial offerings received into one of the categories from the group comprising: Mexican, Italian, American, sandwiches, soups, steak houses, pizza, Brazilian, Chinese, and Japanese.

4. The computer program product of claim 3, wherein the third-party organization comprises one of the Better Business Bureau®, AAA®, the Michelin Guide®, Hotelstar®, Consumer Reports ®, and Zagat®.

5. The computer program product of claim 1, further comprising accepting a merchant acceptance of a consumer request, the merchant acceptance creating a binding option contract between the merchant and the consumer with terms defined by the Request Information.

6. The computer program product of claim 1, further comprising prompting the consumer to accept a commercial offering from the queue before the expiration date.

7. The computer program product of claim 1, further comprising prompting the consumer to accept a commercial offering from the queue upon reaching the expiration date.

8. The computer program product of claim 1, further comprising prioritizing commercial offerings received from merchants into each group of the categories consisting of: closest in geographic proximity, time in business, and cheapest.

9. The computer program product of claim 1, wherein the Request Information further comprises information added by the server, including one or more of the group comprising: the number of requests previously made by said consumer, the number of offers previously accepted by said consumer, an age range of the consumer, dollar amounts spent in response to previous commercial offerings by said consumer, number of previous visits of said consumer to the merchant, and the frequency of visits of said consumer to other merchants in the marketing network by said consumer.

10. The computer program product of claim 1, wherein the Request Information further comprises one or more virtual flags from the group consisting of: a first time eater flag, and a first time requester flag.

11. The computer program product of claim 1, wherein the Request Information further comprises a loyalty ranking exclusively associated with said consumer, the loyalty ranking generated by the server, the loyalty ranking a function of a number of subsequent purchases by the consumer at merchants in the marketing network who made commercial offerings to said consumer which were accepted by said consumer.

12. The computer program product of claim 1, wherein the Request Information is electronically relayed only to merchants in the marketing network who satisfy the principal characteristics identified by said consumer.

13. The computer program product of claim 12, wherein the Request Information is electronically relayed only to merchants in the marketing network who satisfy the principal sub-characteristics identified by said consumer.

14. The computer program product of claim 12, wherein the commercial offering crafted by the merchant comprises a discount percentage rate, a price, and one or more of an additional term, a list of products included, and an expiration date.

15. The computer program product of claim 12, further comprising notifying the merchant asynchronously that the consumer request is one or more of open, expired accepted, and redeemed.

16. The computer program product of claim 1, further comprising legally reducing a predetermined percentage that a merchant is obligated to remunerate to a legal entity controlling the server in response to merchant achieving a predetermined level of revenue production for the legal entity.

17. The computer program product of claim 16, further comprising prompting merchants in the marketing network to increase the percentage of gross revenue they will obligate themselves to remunerate to the legal entity in return for having commercial offerings of the merchant moved up in the queue.

18. The computer program product of claim 17, further comprising prompting merchants in the marketing network to bid against each other for queue position with one of dollars and percentages remunerated to the legal entity.

19. The computer program product of claim 1, further comprising ranking the commercial offerings within the queue on one or more criteria from the group consisting of: identified consumer preferences, price, discount rate, and proximity of an offering merchant.

20. The computer program product of claim 1, wherein the queue rankings asynchronously displayed to the merchants have all merchant names redacted.

21. The computer program product of claim 1, further comprising notifying a merchant receiving a consumer request that the consumer request satisfies one or more merchant defined criteria with audible tones exclusively associated with the criteria satisfied.

22. The computer program product of claim 1, further comprising offering, in response to a merchant instruction, the consumer an increased discount rate in the commercial offerings if the consumer arrives on time to the merchant place of business.

23. The computer program product of claim 1, further comprising:
assessing demerits against merchants who do not respond to consumer requests before the expiration date; and
inversely ranking commercial offerings shown in the queue by merchants in accordance with the offering merchant's respective number of demerits.

24. The computer program product of claim 1, further comprising prompting each merchant to set upper and lower thresholds (the thresholds defining a “Threshold Boundary” between them), wherein a consumer request comprising a budget falling outside the Threshold Boundary is automatically denied by the server on behalf of the merchant.

25. The computer program product of claim 24, wherein the upper threshold is applicable only during certain time periods of a week defined by the merchant.

26. The computer program product of claim 25, further comprising visually flagging attractive consumer requests for merchants based on historical data analysis of consumer requests previously accepted by one or more of a merchant in the marketing network and a plurality of merchants in the marketing network.

27. The computer program product of claim 1, further comprising prompting each merchant to establish a range of prices for a consumer product to be automatically accepted if received in a consumer request.

28. The computer program product of claim 1, further comprising:
calculating a profit which a merchant receiving a consumer request would realize on a consumer request; and
relaying the profit calculation to the merchant.

29. The computer program product of claim 1, further comprising:
assessing points to the consumer accepting commercial offerings based on the dollar size of the commercial offering; and
rewarding the consumer in the future for accumulating points with one or more of priority relay of the consumer's consumer requests, price reductions for the consumer on commercial offerings, wherein the price reduction is assumed by the legal entity controlling the server.

30. The computer program product of claim 1, further comprising prominently featuring a commercial offering on a computer display at merchant request by relaying the commercial offering to consumers outside the subgroup, which outside consumers have not submitted a consumer request.

31. The computer program product of claim 1, wherein a consumer accepting a commercial offering may forward the commercial offering to members of subgroup and obligate the merchant to extend the commercial offering to members of the subgroup.

32. A computer program product comprising a computer readable medium having computer usable program code executable to perform operations for relaying commercial offerings from select merchants to select consumers, the operations of the computer program product comprising:
incorporating a plurality of merchants into a marketing network by storing each respective merchant's name, physical address, telephone number, and email address in persistent computer readable memory;
incorporating a plurality of consumers into a marketing network by storing each respective consumer's cellular telephone number, name, age, and email address in persistent computer readable memory;
prompting a consumer to create a consumer request by:
identifying principal characteristics of a consumer product which the consumer is interested in receiving;
prompting said consumer to rank sub-characteristics of the consumer product which said consumer values most highly;
prompting said consumer to input an expiration date for the consumer request and one or more pieces of information (this information collectively comprising the “Request Information”) from the group consisting of: a subgroup size, a subgroup budget, desired response time, and anticipated time of arrival of the subgroup;
electronically relaying the consumer request and Request Information to a plurality of merchants in the marketing network;
prompting the merchants to craft a commercial offering in the consumer request before the expiration date;
prompting a merchant to upload the commercial offering to a server managing the marketing network in response to receiving the Request Information;
forwarding commercial offerings crafted by a plurality of merchants and uploaded to the server to said consumer;
maintaining a queue of commercial offerings made to said consumer by all merchants in the marketing until the expiration date;
forwarding all commercial offerings received in response to the consumer request to one of said consumer's smart phone and said consumer's personal computer;
relaying the queue to each merchant having crafted a commercial offering at set, predetermined intervals before the expiration date;
prompting the merchants having crafted a commercial offering to improve their offering, subsequent to displaying the queue after the set interval;
storing the Request Information, commercial offerings, and consumer request in computer readable memory in a database for future historical data tracking; and
referencing one or more of the Request Information, the commercial offering and the consumer request in generating Request Information exclusively associated with future consumer requests.

33. The computer program product of claim 32, further comprising prompting a consumer to create a virtual subgroup of consumers, the virtual subgroup of consumers comprising the names of a plurality of commonly acquainted consumers interested in collectively purchasing a commercial offering from a single merchant in the marketing network.

34. The computer program product of claim 32, further comprising receiving a merchant acceptance of a consumer request, the merchant acceptance creating a binding contract between the merchant and the consumer with terms defined by the Request Information.

35. The computer program product of claim 32, further comprising, in response to receiving multiple merchant acceptances simultaneously, automatically selecting an acceptance from the merchant satisfying one of the criteria from the group consisting of: highest rated merchant by a third-party, highest revenue grossing merchant, highest paying merchant to a legal entity controlling the server.

36. The computer program product of claim 32, wherein all active consumer requests made by any member of a subgroup to which the consumer belongs are cross-referenced to identify duplicate consumer requests originating with any member of the subgroup.

37. The computer program product of claim 32, wherein duplicate consumer requests are canceled by the server.

38. The computer program product of claim 32, wherein, at predetermined intervals of time until the deadline is reached, status of queue updates are forwarded to the consumer comprising one or more of the number of merchant submitting commercial offerings, the change in a discount rate since a previous status update, and a number of merchants preparing to make an commercial offering.

39. The computer program product of claim 32, wherein the queue is relayed using one of SMS cellular messaging, email, and asynchronous API website display.

40. The computer program product of claim 32, wherein the geographic location of the consumer is ascertained using mobile locator devices within the smart phones of subgroup consumers and target information from cellular carriers providing the consumer with cellular phone service.

41. The computer program product of claim 32, wherein the geographic location of the consumer is displayed within the queue to merchants in the marketing network, the computer program product further comprising:
prompting a merchant to forward a specialized commercial offering to a consumer who appears to be traveling in close proximity to the merchant;
forwarding the specialized commercial offering to the consumer wirelessly;
prompting merchants which have submitted commercial offerings to a consumer, which commercial offerings were rejected by the consumer, to resubmit a second commercial offering after the consumer request has expired; and
prompting consumers to consider and accept the second commercial offering.

42. The computer program product of claim 32, further comprising notifying the merchant that the consumer has arrived by referencing the geographic location.

43. The computer program product of claim 32, further comprising prompting a merchant to set criteria for automatically rejecting consumer requests comprising Request Information exceeding one or more thresholds defined by the merchant, the thresholds from the group consisting of: price, discount rate, time until arrival, the consumer's distance geographically from the merchant, percentage of previously accepted commercial offerings which the consumer has failed to redeem, and the consumer's budget.

44. The computer program product of claim 32, further comprising digitally highlighting consumer requests in the queue with color coded flags indicative of the magnitude of which Request Information in each respective consumer request exceed the one or more thresholds defined by the merchant.

45. The computer program product of claim 44, further comprising automatically accepting consumer requests flagged with predetermined colors.

46. The computer program product of claim 32, further comprising prompting a merchant to set criteria for automatically rejecting consumer requests comprising Request Information failing to exceed one or more thresholds defined by the merchant, the thresholds from the group consisting of: price, number of previous purchases by the consumer, the consumer's historical average spending, the consumer's distance geographically from the merchant, and the consumer's budget.

47. The computer program product of claim 32, further comprising prompting a merchant to set criteria for automatically accepting consumer requests comprising Request Information exceeding one or more thresholds defined by the merchant, the thresholds from the group consisting of: price, number of previous purchases by the consumer, the consumer's historical average spending, the consumer's distance geographically from the merchant, the consumer's budget, and a rating ascribed to the consumer by one of a system and computer program product effectuating relay of the consumer offer.

48. The computer program product of claim 32, further comprising automatically adjusting a discount rate in a commercial offering in accordance with a percentage of previous commercial offerings made by the merchant which have not been accepted by other consumers in the marketing network.

49. The computer program product of claim 32, further comprising, in response to a consumer receiving a consumer request rejection by a merchant, prompting the consumer to push a virtual button on a browser to see one or more of the thresholds defined by the merchant resulting in the consumer request denial.

50. The computer program product of claim 32, wherein non-expired consumer requests in the merchant queue are ranked by one of: lowest price requested in the Request Information, highest price requested in the Request Information, lowest discount rate requested in the Request Information, highest discount rate requested in the Request Information, closest in geographic proximity of a consumer making the consumer request relative to consumers making other requests in the queue, furthest in geographic proximity of a consumer making the consumer request relative to consumers making other requests in the queue, highest budget in the Request Information, and lowest budget in the Request Information.

51. The computer program product of claim 32, further comprising ranking consumer requests highest in the queue which requests are originated by consumers satisfying demographic criteria set by the merchants, the demographic criteria comprising one or more of age, income, education level, and purchasing history with other merchants in the marketing network.

52. The computer program product of claim 32, further comprising remitting a unique identifier to the consumer and the merchant after the consumer accepts a commercial offering, the unique identifier exclusively associated with the commercial offering, the unique identifier presented by the consumer to the merchant to redeem the commercial offering.

53. The computer program product of claim 52, further comprising requiring the consumer to rate the likelihood that the consumer would visit the merchant in the absence of the commercial offering before allowing the consumer to redeem the merchant offering with the unique identifier.

54. The computer program product of claim 32, further comprising adjusting the price of the commercial offering in relation to a number of previous commercial offering redemptions by the consumer with the merchant.

55. The computer program product of claim 32, wherein the computer usable program code and the server are housed in a kiosk in a metropolitan mall, and wherein the marketing network consists of a plurality of merchants located in the mall.

56. The computer program product of claim 32, further comprising:
displaying a queue of commercial offerings made in response to a consumer request to the consumer making the consumer request;
sorting a commercial offering to the top of the queue, which commercial offering was created by a merchant who has had relatively fewer previous commercial offerings accepted by consumers making previous consumer requests relative to other merchants in the queue.

57. The computer program product of claim 56, further comprising:
automatically adjusting the discount rate offering to the consumer in a commercial offering is response to historical data in computer readable memory indicating that the consumer has failed to redeem commercial offerings accepted in the past from other merchants; and
notifying the consumer that the consumer's discount rate has been automatically adjusted.

58. The computer program product of claim 32, further comprising:
relaying electronic statement to the merchant showing a history of all commercial offerings created, accepted, ignored, rejected and redeemed during a predetermined interval of time, the electronic statement also showing a history of commercial offerings from one or more other merchants;
retroactively changing expired commercial offerings in response to a merchant request; and
predicting, based on historical data, whether the changed commercial offering would have been accepted by the consumer if changed before expiration.

59. The computer program product of claim 32, further comprising relaying a consumer request only to merchants specifically identified by the consumer.

60. A system to perform operations for relaying commercial offerings from select merchants to select consumers, the system comprising:
a merchant incorporator module configured to incorporate a plurality of merchants into a marketing network by storing each respective merchant's name, physical address, age, telephone number, and email address in persistent computer readable memory;
a consumer incorporator module configured to incorporate a plurality of consumers into a marketing network by storing each respective consumer's cellular telephone number, name, and email address in persistent computer readable memory;
a subgroup prompter module configured to prompt a consumer to create a virtual subgroup of consumers, the virtual subgroup of consumers comprising the names of a plurality of commonly acquainted consumers interested in collectively purchasing a commercial product from a single merchant in the marketing network;
a request creator module configured to:
collect principal characteristics of a commercial offering the consumer is interested in receiving on behalf of a subgroup of consumers;
rank sub-characteristics of the commercial offering which said consumer values most highly; and
accept an expiration date for the consumer request and one or more pieces of information (this information collectively comprising the “Request Information”) from the group consisting of: a subgroup size, a subgroup budget, desired response time, and anticipated time of arrival of the subgroup;
a request relayer module configured to electronically relay the consumer request and Request Information to a plurality of merchants in the marketing network;
an offering crafter module configured to craft a commercial offering in response to the consumer request before the expiration date;
a merchant uploader module configured to upload the commercial offering to a server managing the marketing network in response to receiving the Request Information;
an offering forwarder module configured to forward commercial offerings crafted by a plurality of merchants and uploaded to the server to said consumer;
a maintainer module configured to maintain a queue of commercial offerings made to said consumer by all merchants in the marketing until the expiration date;
a forwarder module configured to forward all commercial offerings received in response to the consumer request to one of said consumer's smart phone and said consumer's personal computer;
a displayer module configured to asynchronously display via the Internet the queue to each merchant having crafted a commercial offering;
a reviser module configured to prompt the merchants having crafted a commercial offering to revise their offering;
a storer module configured to store the Request Information, commercial offerings, and consumer request in computer readable memory in a database for future historical data tracking; and
a referencer module configured to reference one or more of the Request Information, the commercial offering and the consumer request in generating Request Information exclusively associated with future consumer requests.

61. The system of claim 60, wherein the Request Information further comprises information added by the server, including one or more of the group comprising: the number of requests previously made by said consumer, the number of offers previously accepted by said consumer, an age range of the consumer, dollar amounts spent in response to previous commercial offerings by said consumer, number of previous visits of said consumer to the merchant, and the frequency of visits of said consumer to other merchants in the marketing network by said consumer.

62. The system of claim 60, further comprising an acceptor module configured to prompt the consumer to accept a commercial offering from the queue upon reaching the expiration date.

63. The system of claim 60, further comprising:
a demerit module configured to assess demerits against merchants who do not respond to consumer requests before the expiration date; and
a penalizer module configured to inversely rank commercial offerings shown in the queue by merchants in accordance with the offering merchant's respective number of demerits.

64. The system of claim 60, further comprising an automatic selector module configured to automatically select an acceptance from the merchant satisfying one of the criteria from the group consisting of: highest rated merchant by a third-party, highest revenue grossing merchant, highest paying merchant to a legal entity controlling the server.
